(19) United States
(12) Patent Application Publication
(10) Pub. No.: US 2011/0186146 A1
(43) Pub. Date: Aug. 4, 2011

(54) Assemblable faucet

(76) Inventor: Bichang Guan, Taichung (TW)

(21) Appl. No.: 12/700,431

(22) Filed: Feb. 4, 2010

(51) Int. Cl. F16K 43/00

(52) U.S. Cl. 137/315.01; 137/801

(57) ABSTRACT

An assemblable faucet includes a body having a holder, at least one inlet, an outlet located at the holder, a channel communicating with the inlet and the outlet, and at least one valve seat communicating with the channel; the valve seat being used to receive and position a control valve set to control water from the inlet to flow toward the outlet; an outlet pipe including an inflow connector with an aperture, including a spray head with a spout, and including a tunnel communicating with the inflow connector and the spray head; the inflow connector being tightly connected to the holder of the body so that the aperture is in communication with the outlet of the holder, such that the water from the outlet of the body flows to the spout along the tunnel of the outlet pipe.

### BACKGROUND OF THE INVENTION

1. Field of the Invention

The present invention relates to an assemblable faucet.

2. Description of the Prior Art

A body of conventional assemblable faucet and a conventional outlet pipe are made of cooper material with lead substances by casting and cooper tube inflating method, and then they are worked mechanically, trimmed, and polished in order. To prevent lead pollution, a lead eliminating process is necessary, and an inflow connector and an outlet connector are pre-formed and then welded manually to connect with the body to form the outlet pipe. Thereafter, the formed outlet pipe are welded with the body of the faucet together to have the surface working process, hence the body of the faucet and the outlet pipe are integrally welded, casing pollution, high production cost, and low product yield. Besides, the body is made of cooper material to have heavy weight that is carried inconveniently.

The present invention has arisen to mitigate and/or obviate the afore-described disadvantages.

### SUMMARY OF THE INVENTION

The primary object of the present invention is to provide an assemblable faucet which is capable of overcoming the shortcomings of the conventional plastic outlet pipe and making process thereof.

A further object of the present invention is to provide an assemblable faucet which the body and the outlet pipe are assembled together in a movable assembling manner instead of a conventional welding structure so that the body and the outlet pipe are integrally made of plastic material instead of cooper material with lead substances to lower welding and lead-eliminating costs, to enhance product yield, and to simplify manufacturing process.

Another object of the present invention is to provide an assemblable faucet which the manufacture pollution is overcome, and the assemblable faucet is mass produced quickly and at good quality.

Also another object of the present invention is to provide an assemblable faucet which the assemblable faucet rejection molded from plastic material is light to be portable easily.

An assemblable faucet in accordance with the present invention comprises:

a body including a holder, at least one inlet, an outlet located at the holder, a channel communicating with the inlet and the outlet, and at least one valve seat communicating with the channel; the valve seat being used to receive and position a control valve set to control water from the inlet to flow toward the outlet;

an outlet pipe including an inflow connector with an aperture, including a spray head with a spout, and including a tunnel communicating with the inflow connector and the spray head; the inflow connector being tightly connected to the holder of the body so that the aperture is in communication with the outlet of the holder, such that the water from the outlet of the body flows to the spout along the tunnel of the outlet pipe;

wherein the inflow connector of the outlet pipe is rotably engaged to the holder of the body;

a body including a holder, at least one inlet, an outlet located at the holder, a channel communicating with the inlet and the outlet, and at least one valve seat communicating with the channel; the valve seat being used to receive and position a control valve set to control water from the inlet to flow toward the outlet;

an outlet pipe including an inflow connector with an aperture, including a spray head with a spout, and including a tunnel communicating with the inflow connector and the spray head; the inflow connector being tightly connected to the holder of the body so that the aperture is in communication with the outlet of the holder, such that the water from the outlet of the body flows to the spout along the tunnel of the outlet pipe.

### BRIEF DESCRIPTION OF THE DRAWINGS

FIG. 1 is a perspective view showing a body of an assemblable faucet being assembled with an outlet pipe in accordance with a first embodiment of the present invention;

FIG. 2 is a perspective view showing the exploded components of the body of the assemblable faucet and the outlet pipe in accordance with the first embodiment of the present invention;

FIG. 3 is a perspective view showing the cross section of the assemblable faucet in accordance with the first embodiment of the present invention;

FIG. 4 is another perspective view showing the cross section of the assemblable faucet in accordance with the first embodiment of the present invention;

FIG. 5 is a perspective view showing the cross section of the outlet pipe in accordance with the first embodiment of the present invention;

FIG. 6 is a partial perspective view showing a connection of an outlet of the body in accordance with the first embodiment of the present invention;

FIG. 7 is a partial perspective view showing a connection of the outlet pipe in accordance with the first embodiment of the present invention;

FIG. 8 is a perspective view showing the cross section of an assemblable faucet in accordance with a second embodiment of the present invention;

FIG. 9 is a perspective view showing the cross section of an assemblable faucet in accordance with a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

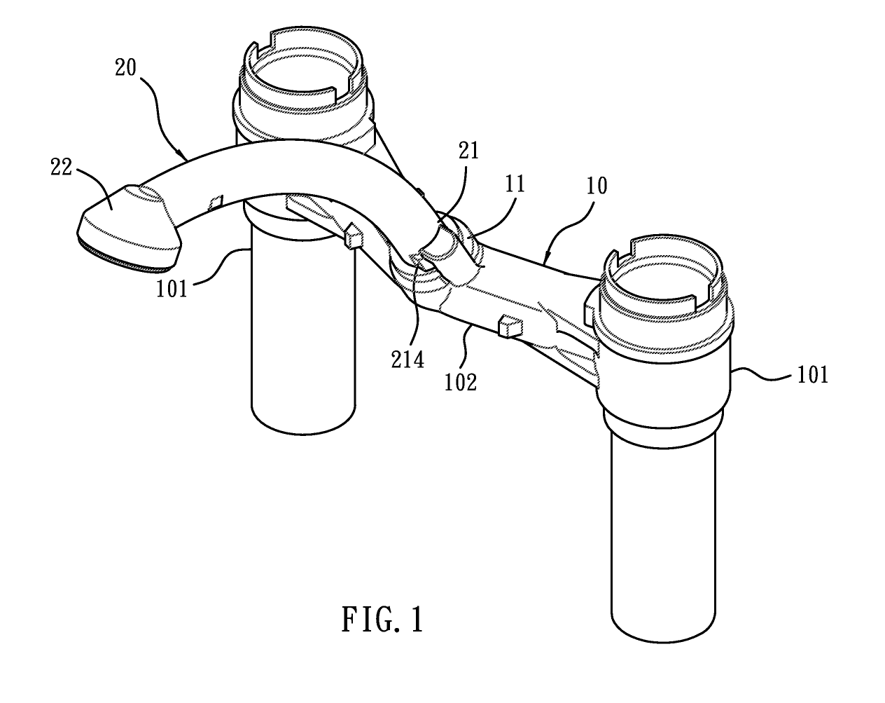

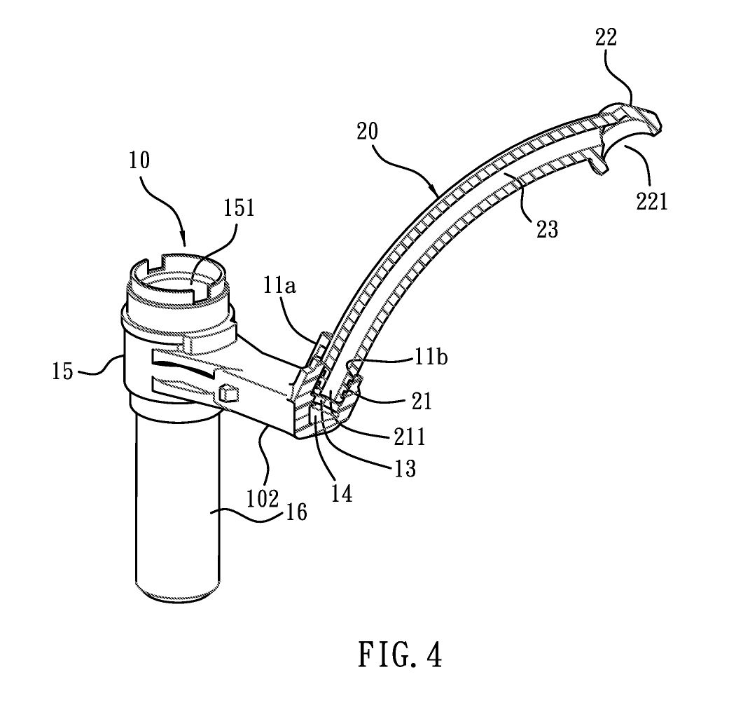

Referring to FIGS. 1-5, an assemblable faucet according to a first embodiment of the present invention comprises a body 10 and an outlet pipe 20, wherein

the body 10 is made of plastic material, and the plastic material includes nylon mixed and glass fiber mixed together, the body 10 includes a first part member pre-injection molded and a second part member rejection molded and integrally wrapped by the first part member. In this embodiment, the body 10 is provided with double inlets and formed in a H shape, and also includes two longitudinal segments 101 disposed on two sides thereof respectively, and includes a lateral segment 102 defined between and communicating with the two longitudinal segments 101. The body 10 further includes a holder 11, two inlets 12, an outlet 13 located at the holder 11, a channel 14 communicating with the inlets 12 and the outlet 13, and two valve seats 15 communicating with the channel 14.

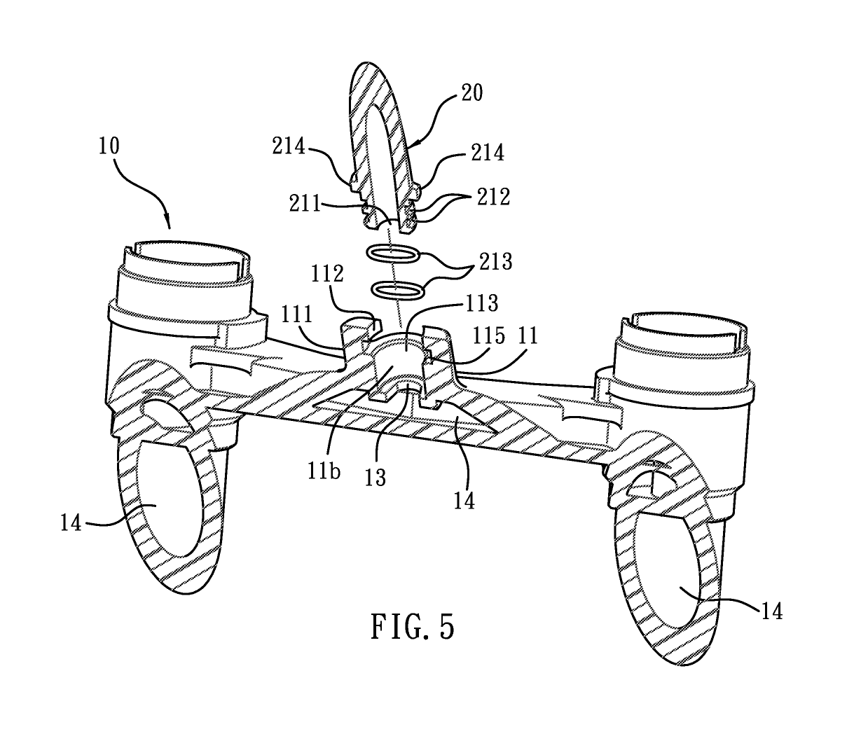

The valve seat 15 is formed on a top end of the longitudinal segment 101, and the longitudinal segment 101 includes a support foot 16 extending from a bottom end of the valve seat 15, the inlet 12 is formed on a bottom end of the support foot 16, wherein one inlet 12 is used to feed cold water, and another inlet 12 is applied to feed hot water. The valve seat 15 includes a receiving groove 151 as shown in FIG. 5 to receive and position a control valve set used to control cold and hot waters to flow toward the outlet 13 individually. The holder 11 and the outlet 13 are defined on a middle portion of the lateral segment 102.

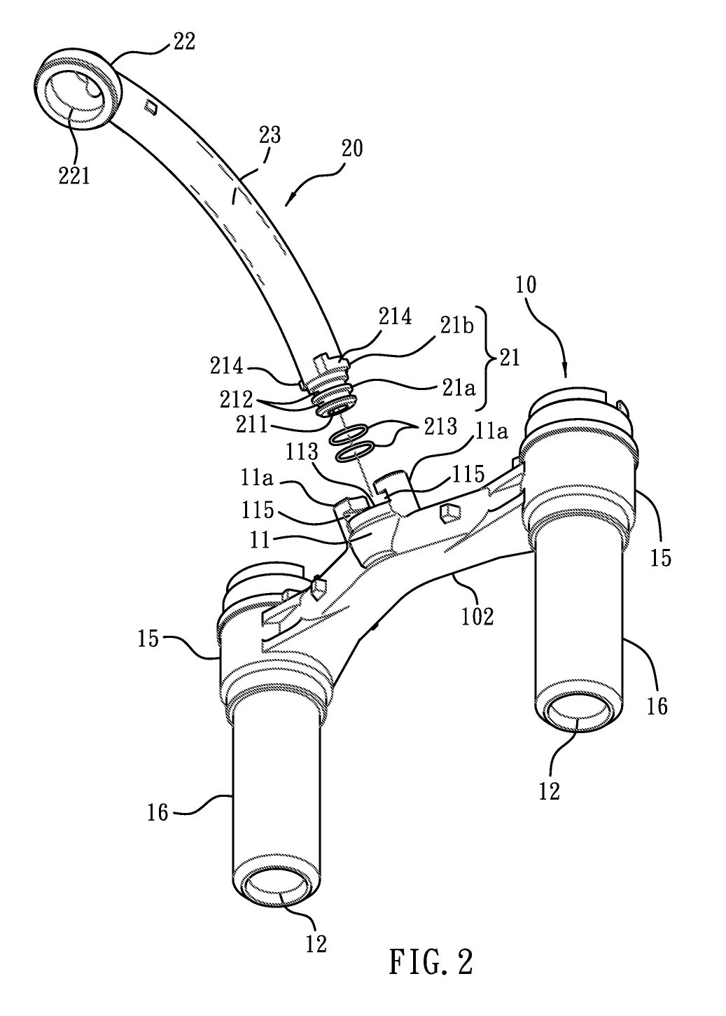

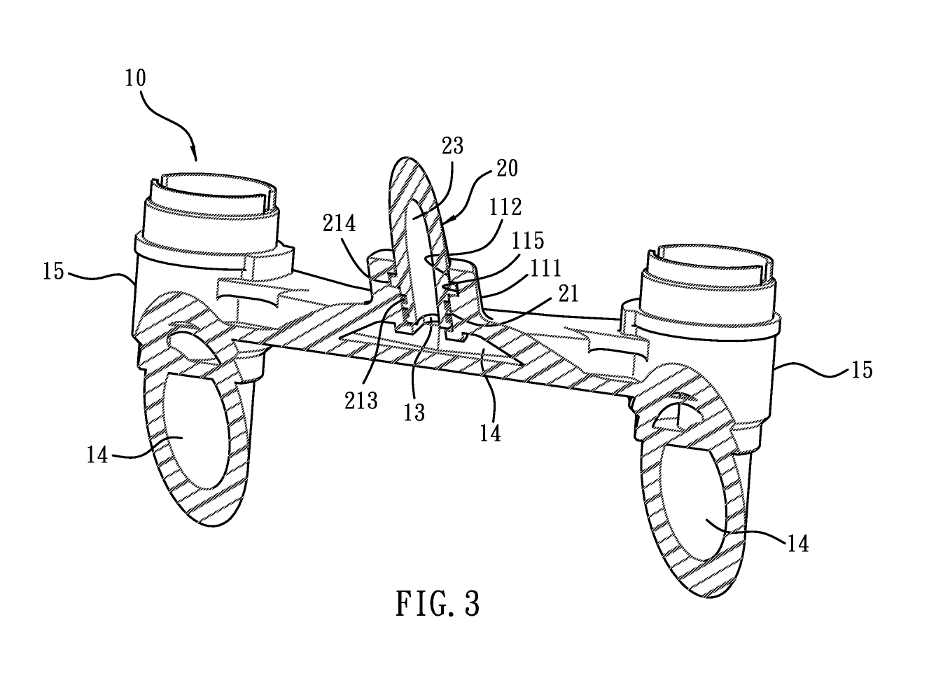

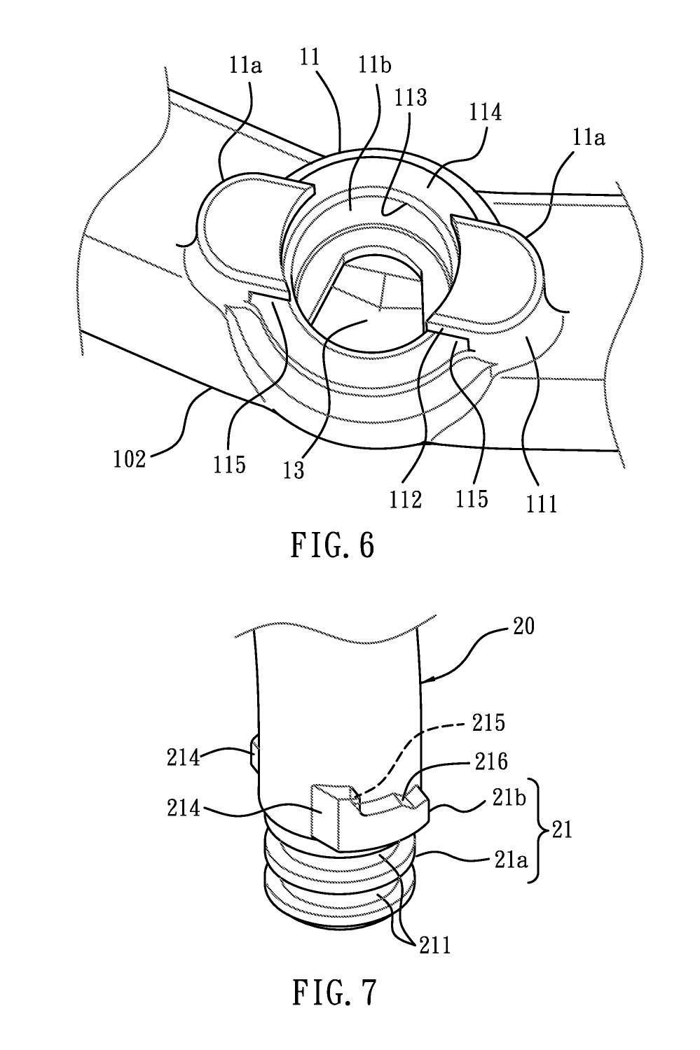

The holder 11 includes two fixing paws 11a integrally extending from an outer wall of the body 10, and an inner chamber 11b defined between the fixing paws 11a as illustrated in FIGS. 3-6. The fixing paw 11a includes a vertically extending portion 111, and the extending portion 111 includes a hook 112 disposed on a top end thereof. The inner chamber 11b includes the outlet 12 disposed on a bottom end thereof and a hole 113 mounted on a top end thereof, and the hole 113 includes a retaining recess 115 defined between a peripheral side 114 thereof and the fixing paws 11a as shown in FIGS. 2 and 6.

The outlet pipe 20 includes an inflow connector 21 with an aperture 211 and a spray head 22 with a spout 221, and a tunnel 22 communicating with the inflow connector 21 and the spray head 22. The inflow connector 21 is tightly connected to the holder 11 of the body 10 as illustrated in FIGS. 1, 3, and 4 so that the aperture 211 is in communication with the outlet 13 of the holder 11, such that the cold, hot, or mixed cold and hot water flows to the spout 221 along the tunnel 23 of the outlet pipe 20.

The inflow connector 21 of the outlet pipe 20 includes an insertion 21a and a rotable locking portion 21b fixed in the insertion 21a as shown in FIG. 7, the insertion 21a is inserted to the inner chamber 11b from the hole 113 of the body 10, and includes two slots 212 arranged around an outer rim thereof to fit two pads 213 individually so as to engage with an inner wall of the inner chamber 11b. The rotable locking portion 21b includes two symmetrical L-shaped projections 214 attached on an outer surface thereof to be retained to the retaining recesses 115. The projection 214 includes a stop wall 215 disposed thereon so that the projection 214 is rotated into the retaining recess 115 at a predetermined angle, and the hooks 112 are stopped and limited by each other, and the projection 214 includes a guiding plane 216 formed on a top end thereof proximate to a rotated side thereof so that the projection 214 is rotated into the retaining recess 115 by using the guiding plane 216, and the top and the bottom surfaces of the projection 214 engage with a bottom surface of the hook 112 and the peripheral side 114 tightly.

In the assembly, the insertion 21a of the inflow connector 21 is aligned to the inner chamber 11b of the body 10, and the projection 214 leaves the fixing paw 11a away so that the insertion 21a is inserted to the inner chamber 11b from the hole 113 until the top surface of the projection 214 engages with the peripheral side 114. Thereafter, the outlet pipe 20 is rotated 90 degrees in anticlockwise direction so that the rotated side of the projection 214 is rotated to engage with the retaining recess 115 until the stop wall 215 contacts with the hook 112, therefore the projection 214 is retained in the retaining recess 115, and the insertion 21a of the outlet pipe 20 is fitted to the inner chamber 11b tightly, assembling the outlet pipe 20 to the body 10 easily.

The support foot 16 of body 10 further includes a section of outer thread integrally formed thereon to position the body 10. However, the outer threads of the support foot 16 can be replaced by a cooper sleeve fitted thereon, and the cooper sleeve includes external threads formed on an outer periphery thereof.

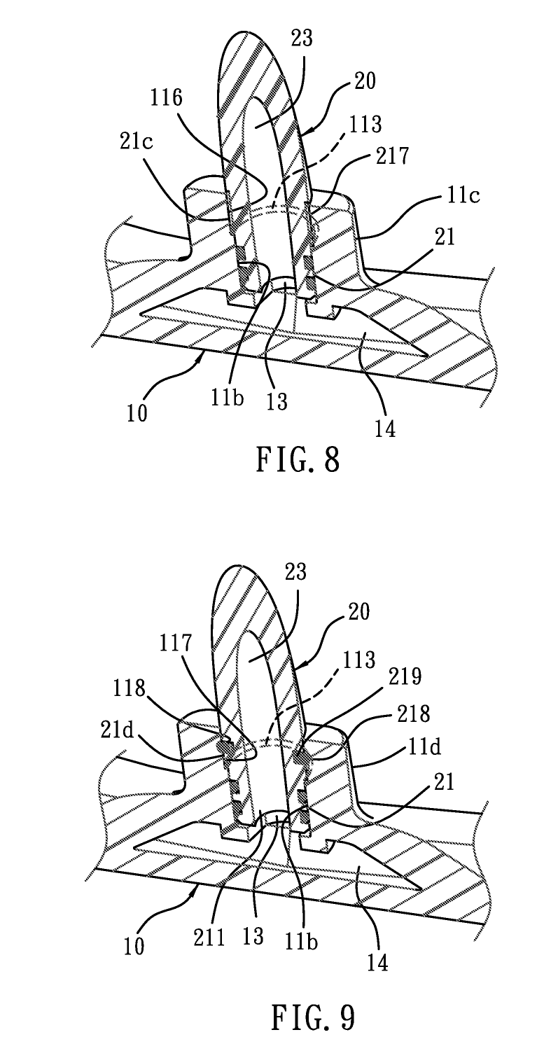

Referring to FIG. 8, a difference of an assemblable faucet according to a second embodiment of the present invention from that of the first embodiment is change a rotably engaging method of the first embodiment to a rotably screwing method. For example, the two fixing paw 11a are changed to a screwing portion 11c with a bore 116, and the inner chamber 11b, the outlet 13, and the hole 113 are kept. The rotable locking portion 21b of the inflow connector 21 of the outlet pipe 20 is changed to a coupling portion 21c with external screws 217 arranged around an outer rim thereof such that when the external screws 217 of the coupling portion 21c of the inflow connector 21 is screwed with the bore 116 of the screwing portion 11c, the insertion 21a is rotably screwed to the inner chamber 11b from the hole 113 of the body 10 so that the insertion 21a engages with the inner chamber 11b tightly, assembling the body 10 to the outlet pipe 20 easily.

With reference to FIG. 9, a difference of an assemblable faucet according to a third embodiment of the present invention from that of the first embodiment is change a rotably engaging method of the first embodiment to an engageably inserted method. For example, the two fixing paws 11a are changed to an engaging portion 11d. The engaging portion 11d includes an engagement room 117, and the engagement room 117 includes at least one orifice 118 disposed on an inner rim thereof. In this embodiment, two symmetrical orifices 118 are provided, and the engagement room 117 includes an inner chamber 11b mounted on a lower side thereof, a hole 113 fixed on a top end thereof, and an outlet 13 attached on a bottom end thereof. The rotable locking portion 21b of the inflow connector 21 of the outlet pipe 20 is changed to a connecting portion 21d, and the connecting portion 21d includes at least one defining ball 218 secured on an outer rim thereof. In this embodiment, two symmetrical defining balls 218 are provided, and the defining ball 218 is pressed by a compression spring 219 to extend outward so as to be engaged in the orifice 118 of the engagement room 117 of the body 10. To align the defining ball 218 to the orifice 118 easily, a sliding groove fixed to an inner rim of an upper side of the orifice 118 relative to the engagement room 117 to position the defining ball 218 precisely and quickly and to slide the defining ball 118 to the sliding groove, accordingly when the outlet pipe 20 is retained with the orifice 118 of the engagement room 117 of the body 10 by using the defining ball 218 of the connecting portion 21d of the inflow connector 21, the insertion 21a is inserted to the hole 113 of the inner chamber 11b from the body 10 to be retained.

The body 10 and the outlet pipe 20 are assembled together in a movable assembling manner instead of a conventional welding structure so that the body 10 and the outlet pipe 20 are integrally made of plastic material instead of cooper material with lead substances to lower welding and lead-eliminating costs, to enhance product yield, and to simplify manufacturing process. Furthermore, the manufacture pollution is overcome, and the assemblable faucet is mass produced quickly and at good quality. Also, the assemblable faucet rejection molded from plastic material is light to be portable easily.

While we have shown and described various embodiments in accordance with the present invention, it is clear to those skilled in the art that further embodiments may be made without departing from the scope of the present invention.

What is claimed is:

1. An assemblable faucet comprising
a body including a holder, at least one inlet, an outlet located at the holder, a channel communicating with the inlet and the outlet, and at least one valve seat communicating with the channel; the valve seat being used to receive and position a control valve set to control water from the inlet to flow toward the outlet;
an outlet pipe including an inflow connector with an aperture, including a spray head with a spout, and including a tunnel communicating with the inflow connector and the spray head; the inflow connector being tightly connected to the holder of the body so that the aperture is in communication with the outlet of the holder, such that the water from the outlet of the body flows to the spout along the tunnel of the outlet pipe.

2. The assemblable faucet as claimed in claim 1, wherein the inflow connector of the outlet pipe is rotably engaged to the holder of the body.

3. The assemblable faucet as claimed in claim 2, wherein the holder includes two fixing paws integrally extending from an outer wall of the body, and an inner chamber defined between the fixing paws, and the extending portion includes a hook disposed on a top end thereof; the inner chamber includes the outlet disposed on a bottom end thereof and a hole mounted on a top end thereof, and the hole includes a retaining recess defined between a peripheral side thereof and the fixing paws; the inflow connector of the outlet pipe includes an insertion and a rotable locking portion fixed in the insertion, the insertion is inserted to the inner chamber from the hole of the body, and includes at least one slot arranged around an outer rim thereof to fit a pad so as to engage with an inner wall of the inner chamber; the rotable locking portion includes two symmetrical projections attached on an outer surface thereof to be retained to the retaining recesses.

4. The assemblable faucet as claimed in claim 3, wherein the projection includes a stop wall disposed thereon so that the projection is rotated into the retaining recess at a predetermined angle, and the hooks are stopped and limited by each other.

5. The assemblable faucet as claimed in claim 4, wherein the projection is formed in a L shape and includes a guiding plane formed on a top end thereof proximate to a rotated side thereof.

6. The assemblable faucet as claimed in claim 3, wherein the body is integrally made of plastic material.

7. The assemblable faucet as claimed in claim 4, wherein the outlet pipe is integrally made of plastic material.

8. The assemblable faucet as claimed in claim 1, wherein the insertion of the outlet pipe is rotably screwed to the holder of the body.

9. The assemblable faucet as claimed in claim 8, wherein the holder includes a screwing portion integrally extending from an outer wall of the body, and an inner chamber located at the screwing portion, the screwing portion includes a bore; and the inner chamber includes an outlet disposed on a bottom end thereof and a hole mounted on a top end thereof; the inflow connector of the outlet pipe includes an insertion and a coupling portion fixed in the insertion, the insertion is inserted to the inner chamber from the hole of the body, and includes at least one slot arranged around an outer rim thereof to fit a pad so as to engage with an inner wall of the inner chamber; the coupling portion includes external screws arranged around an outer rim thereof so as to screw with the bore of the screwing portion.

10. The assemblable faucet as claimed in claim 1, wherein the insertion of the outlet pipe is inserted to the holder of the body to be retained.

11. The assemblable faucet as claimed in claim 10, wherein the holder includes an engaging portion integrally extending from an outer wall of the body, and an inner chamber located at the engaging portion, the engaging portion includes an engagement room, and the engagement room includes at least one orifice disposed on an inner rim thereof, and includes an inner chamber mounted on a lower side thereof; and the inner chamber includes an outlet disposed on a bottom end thereof and a hole mounted on a top end thereof; the inflow connector of the outlet pipe includes an insertion and a connection portion fixed in the insertion, the insertion is inserted to the inner chamber from the engagement room and the hole of the body, and includes at least one slot arranged around an outer rim thereof to fit a pad so as to engage with an inner wall of the inner chamber; and the connecting portion includes at least one defining ball secured on an outer rim thereof, and the defining ball is pressed by a compression spring to extend outward so as to be engaged in the orifice of the engagement room.

12. The assemblable faucet as claimed in claim 1, wherein the body is formed in a H shape, and includes two longitudinal segments disposed on two sides thereof respectively, and includes a lateral segment defined between and communicating with the two longitudinal segments; the longitudinal segment includes the valve seat formed on a top end thereof, and includes a support foot extending from a bottom end thereof, the support foot includes the inlet formed on a bottom end thereof, the holder and the outlet are defined on a middle portion of the lateral segment.

13. The assemblable faucet as claimed in claim 12, wherein the body is integrally made of plastic material.

14. The assemblable faucet as claimed in claim 12, wherein the body is integrally made of plastic material, and the support foot further includes a section of outer thread integrally formed thereon

15. The assemblable faucet as claimed in claim 12, wherein the body is integrally made of plastic material, the support foot includes a cooper sleeve fitted thereon, and the cooper sleeve includes external threads formed on an outer periphery thereof.
